(19) United States
(12) Patent Application Publication
(10) Pub. No.: US 2004/0214705 A1
(43) Pub. Date: Oct. 28, 2004

(54) Method of forming shipping containers

(76) Inventors: Jeffrey M. Gardner, West Chicago, IL (US); Nicholas A. Philips, Sugar Grove, IL (US)

Correspondence Address: Weyerhaeuser Company, 33663 Weyerhaeuser Way South, Federal Way, WA, 98003, US

(21) Appl. No.: 10/423,804

(22) Filed: Apr. 24, 2003

(51) Int. Cl. B31B 7/00

(52) U.S. Cl. 493/93

(57) ABSTRACT

The invention is a method of forming Bliss-type boxes by combining containerboard body blanks with end panel or box liner blanks. A Bliss box former is used in direct association with a slitter scorer. The slitter scorer is supplied with containerboard sheets having a width which is equal to the length of the box liner blanks. The sheets have a length which is equal to a whole number multiple of the width of the box liner blanks. Box liners are severed and scored one-by-one as needed by the Bliss box former. This reduces the need for maintaining multiple sizes of box liner blanks in inventory and greatly simplifies setup when boxes are being made that differ only in width.

The present invention is a method whereby Bliss-type shipping containers can be easily formed without the need for supplying precut end blanks. The method is particularly well suited for forming two piece body wrap Bliss-type boxes.

### BACKGROUND OF THE INVENTION

So-called Bliss boxes are a general type well known in the shipping container industry. They are formed from multiple pieces of corrugated container board glued together to form a single unit. Typically, one piece forms the bottom, side walls, and the major top flaps. This is generally called the body portion. Separate pieces are glued in to form the end walls and minor top flaps, if any. One variation of this is called a body wrap box. In this type both end portions are formed from a wrapped around single piece or “box liner” which usually overlies (but may also underlie) the body blank forming the bottom and sides of the box. An example of Bliss-type boxes and equipment for forming them are well described in U.S. Pat. No. 4,197,789 to Moen. Normally precut and scored body and end or box liner blanks are delivered to the former. When size changes are necessary, the equipment must be shut down and major adjustments made. This applies to not only to the box former but also the slitters and die cutters forming the body and end blanks which are formed separately from the large sheets produced by the corrugator. The multi-component construction of Bliss boxes enables corrugated containerboard of different weights to be used in the most critical stress bearing areas. As an example, the sides and bottom portion might be made of heavier weight board then the ends or vice versa. Typically the Bliss box former will be at a customer's location where the boxes are ultimately filled with product. The producer of the corrugated board supplies precut and scored blanks which must then be held in inventory, often in multiple sizes.

Occasionally it is desired to fill an order of boxes that differ in only a single dimension; e.g., width. In the past this has still required the time consuming changes noted above. The present invention is beneficial in that it reduces the time and complexity of making setup changes where only a single dimension is being changed. In addition, it eliminates the need for the end or box liner pieces of several sizes to be held in inventory.

### SUMMARY OF THE INVENTION

It should be understood that some of the terms used in the following description are relative; e.g., length, width, and depth and bottom and sides can sometimes be used interchangeably, depending on the particular box construction. A score or score line is a linear indentation formed in a corrugated board container blank at a location which will later be bent as a container is erected. A container blank is a flat piece of board of appropriate outline and scoring pattern which is used for subsequent formation of a container. Bliss-type boxes have many style variations but all are of multi-component construction. By multi-component is meant that at least two differently configured container blanks are required and are glued together during assembly.

The present invention is directed to a method of forming a Bliss-type corrugated shipping container. It is particularly directed to formation of a two piece body wrap-type box. The method first requires providing a conventional Bliss box former. The type described in U.S. Pat. No. 4,197,789 may be mentioned as a non-limiting example. This is supplied in conventional fashion with a stack of precut and scored container board body blanks which are then singulated for formation of individual boxes. In past practice the blanks for the end or box liner portions of the boxes would also be separately precut and scored and then delivered in stacks to the Bliss former. However, it has now been found advantageous to have a dedicated slitter/scorer coupled to the Bliss former. The slitter scorer forms the box liner blanks as needed. A supply of containerboard sheets is delivered to the slitter/sorter from the corrugator. These sheets most preferably have a width dimension that is identical with the required length dimension of the box liner blanks. Further, the sheets most preferably have a length dimension that is a whole number multiple of the required width dimension of the box liner blanks. The sheets of corrugated board are fed singly into the slitter/scorer where the box liner blanks are severed and scored for delivery to the Bliss former. The slitter in this application has only the need to make a transverse cut across the sheet. In the Bliss former the body blanks and box liner blanks are combined and glued into Bliss-type boxes.

Many different types of Bliss box formers and slitter/scorers are suitable for combination and use with the present method. The invention is not in any way limited to a single type.

On some occasions it is necessary to form boxes that may differ in a single length or width dimension. When the length of the sheets supplied for forming the end panels are whole number multiples of the desired container widths, the only change needed is to reset the Bliss former and slitter to the different width. This greatly simplifies and reduces the time and container blank inventory previously necessary for making dimension changes.

It is an object of the invention to provide a simplified method for preparing Bliss-type corrugated shipping containers.

It is a further object to provide a method in which a dedicated slitter/scorer is in conjunction with the Bliss former to supply box liner panels for the boxes, the box liners being formed as needed from a supply of larger sheets.

It is one more object to provide an integrated Bliss box former and slitter/scorer for making the shipping containers.

These and many other objects will become readily apparent upon reading the following detailed description taken in conjunction with the drawings.

### BRIEF DESCRIPTION OF THE DRAWINGS

FIG. 1 shows in plan view the two components of a body wrap Bliss box.

FIG. 2 is a diagrammatic plan view of a Bliss box former with an adjacent slitter/scorer supplying the box end panels.

### DETAILED DESCRIPTION OF THE PREFERRED EMBODIMENTS

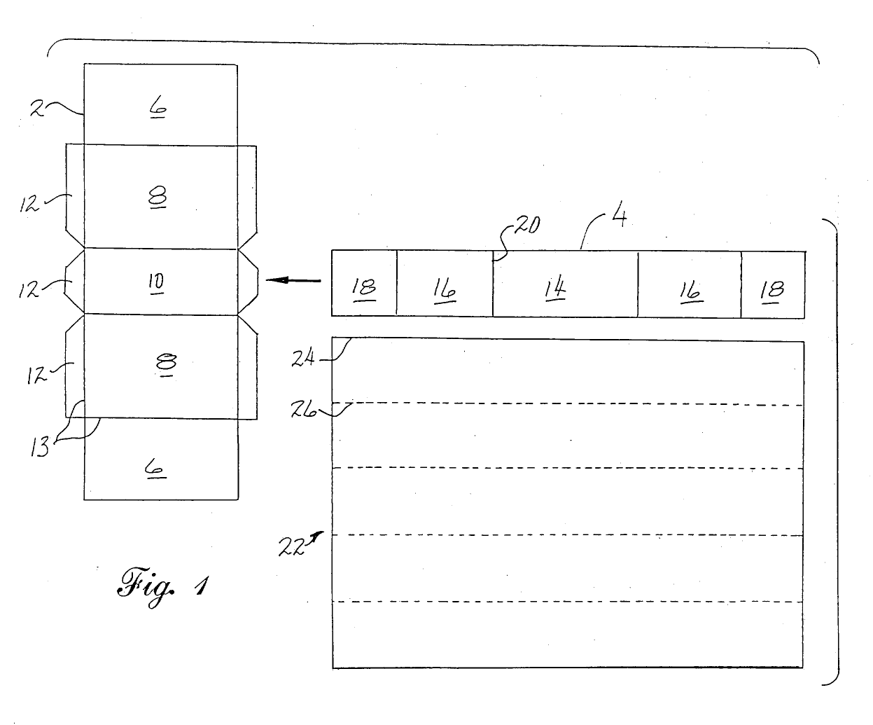

The invention can now be readily understood by reference to the drawings. FIG. 1 shows in plan view the two components of a body wrap-type Bliss box. The precut and scored body panel is seen at 2 and a scored end panel at 4. The body panel has upper major flaps 6, side panels 8, and a bottom panel 10. Flanges 12 serve for adhesively uniting the body wrap panel to the end panels. Score lines 13 indicate where folds will be made when the box is assembled. Box liner 4 has section 14 which will overlie bottom section 10 of body panel 2. It further has panels 16 which will become the end panels and panels 18 which are the upper minor flaps. The box liners have score lines 20 along which folds will be made when the box is assembled. Box liner 4 has been severed from a larger sheet 22 along cut line 24. Additional box liners will be cut along lines 26 as they are needed for assembly of subsequent boxes. It will be noted that the width of sheets 22 is identical to the length of box liner panels 4. Further, the length of sheets 22 is equal to a whole number multiple of the width of box liner 4. While this is not absolutely essential, it is highly desirable if no waste is to be created.

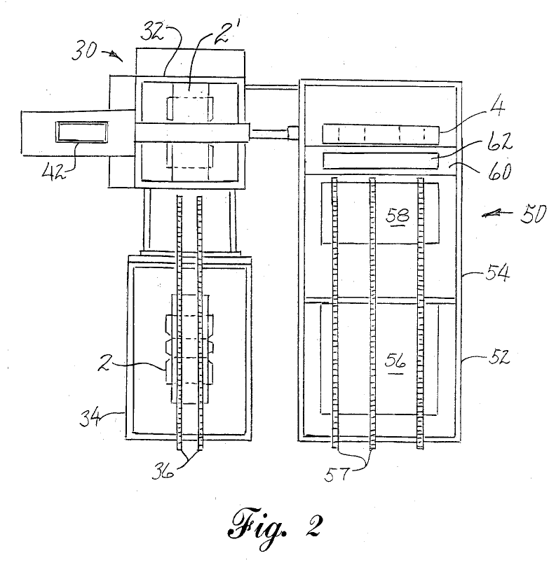

FIG. 2 is a diagrammatic plan representation of the combination of a Bliss box former, generally shown at 30, in combination with a slitter/scorer 50 which will supply the box liners 4. The box former itself is represented at 32. It contains an infeed section 34 which is supplied with a stack of precut and slotted body blanks 2. These are transported to the box former by conveyor chains 36. Body blank 2′ is in position in box former 32 where it will be united with a box liner 4. Finished boxes 42 leave the former. The slitter/scorer 50 has a storage zone 52 and a transport zone 54. The storage area receives loads of corrugated paperboard sheets 56 from the corrugator. These have most preferably been cut to a width equal to the length of the box liners 4. The length of sheets 56 should most preferably be a whole number multiple of the width of box liners 4. Corrugated sheets 56 are singulated and moved by conveyor chains 57 to the transport zone 54. Here the individual box liners are transversely severed from sheets 58 and conventionally scored at location 60, an area not shown in detail on the drawing. One such severed panel 62 is seen in place ready to be scored and transported to the next station where it will be moved, as needed, to the Bliss box former 30.

The present invention has the major advantage that the box liners need not be precut, scored, and held in inventory as is the usual practice. The need for a large inventory of box liners of different sizes is eliminated. This improves overall speed of the assembly operation. It has the additional advantage that boxes of different widths can be formed with minimal setup adjustment as long as the box widths have a whole number relationship to the length of panels 56.

It will be immediately apparent that many variations not described herein are possible. Bliss-type boxes of many different sizes and styles can be formed. It is the intention of the inventors that these should be included within the broad scope of the invention if encompassed within the following claims.

1. A method of forming a Bliss-type corrugated shipping container which comprises:
providing a Bliss-type box former;
supplying precut and scored containerboard body blanks to the former, the blanks forming the bottom and side panels of a box;
providing a slitter/scorer in direct association with the box former to supply box liner blanks to the box former, the box liner blanks having a length and a width;
supplying containerboard sheets to the slitter scorer to form box liner blanks;
feeding the sheets to slitter/scorer to provide one-at a time scored box liner units for the box former;
supplying the box liner blanks to the former; and
combining the body blanks and box liner blanks to form Bliss-type shipping containers.

2. The method of claim 1 which forms a body wrap-type Bliss container in which a single box liner blank is formed to provide both ends of the container.

3. The method of claim 1 in which the sheets fed to the slitter/scorer have a width which is equal to the length of the box liner blanks and a length which is a whole number multiple of the width of the box liner blanks.

4. A method of forming a Bliss-type corrugated shipping container which comprises:
providing at a box forming location precut and scored containerboard body blanks, the blanks forming the bottom and side panels defining the length of the box;
providing at the box forming location a containerboard sheet to form box liner blanks, the sheet having a width which is equal to the length of the box liner blanks, the sheets further having a length which is at least a whole number multiple of the width of the box liner blanks;
slitting the sheet to provide box liner units of suitable width for the container; and
combining the body blanks and box liner blanks to form a shipping container.
